(19) United States
(12) Patent Application Publication
(10) Pub. No.: US 2026/0024521 A1
(43) Pub. Date: Jan. 22, 2026

(54) SYSTEMS AND METHODS FOR AI-BASED AUDIO NARRATION

(71) Applicant: Philip Dana Marshall, Portland, OR (US)

(72) Inventor: Philip Dana Marshall, Portland, OR (US)

(21) Appl. No.: 19/275,780

(22) Filed: Jul. 21, 2025

Related U.S. Application Data
(60) Provisional application No. 63/674,144, filed on Jul. 22, 2024.

(51) Int. Cl. G10L 13/08; G06F 40/205; G06F 40/263; G06F 40/40; G10L 13/027

(52) U.S. Cl. CPC G10L 13/086; G06F 40/205; G06F 40/263; G06F 40/40; G10L 13/027

(57) ABSTRACT

Systems and methods are herein provided for an audio narration system. A method for an audio narration system, comprising: receiving text data; generating, from the text data, parsed text data and related data via a trained text parsing large language model (LLM), wherein the parsed text data comprises a plurality of passages of one or more passage profiles; assigning one or more voices to the plurality of passages; and generating audio data of the parsed text data, wherein the audio data comprises an audio passage for each of the plurality of passages.

### CROSS REFERENCE TO RELATED APPLICATIONS

The present application claims priority to U.S. Provisional Application No. 63/674,144, entitled “SYSTEMS AND METHODS FOR AI-BASED AUDIO NARRATION”, and filed on Jul. 22, 2024. The entire contents of the above-listed application are hereby incorporated by reference for all purposes.

### FIELD

Embodiments of the subject matter disclosed herein relate to audio narration, and more particularly to AI-based processing of text data for audio narration.

### BACKGROUND AND SUMMARY

Audio-based versions of written content have become increasingly popular among consumers. With increased accessibility of audio platforms (e.g., Spotify, Audible, Libby, and the like), more and more consumers are choosing to listen to audiobooks, screenplays, essays, and other types of works rather than reading text. Historically, self-publishing a written work has been difficult and monetarily costly. However, with advancement of platforms such as Kindle Direct Publishing and other self-publishing platforms, publishing written works has become more accessible to writers directly. Additionally, online-based platforms (e.g., Wattpad, Medium, Reddit, etc.) have provided accessible and cost-effective avenues for self-publishing shorter written works.

However, publishing audio versions of books, short stories, screenplays, essays, and the like remains expensive and difficult. In many circumstances, audio narration still demands someone read the text aloud in order to generate an audio version of the written text. Also, many text-to-speech applications with voice models may only present single-voice narration options, rather than allowing for multi-voice narration, which may provide a more immersive listening experience for character-driven works. Further, there are few options for taking narrated works and publishing them online for readers (listeners) to stream.

The inventors herein have recognized the aforementioned issues and developed systems and methods that at least partially address these issues. In one example, methods and system are herein disclosed for inputting text data, for example a story, chapter of a book, or the like, into a trained parsing large language model (LLM). The trained text parsing LLM may be trained to process the text data in order to output parsed text and related data. The parsed text, in the form of passages, align with a plurality of profiles. The profiles may encompass character attributes, narrator attributes, and the like, including the personality traits of characters, the tone of speech being used, along with the overall context of the story or genre.

The text data may also be inputted into a text classification LLM that is trained to process the text data to determine the language the text is in, a category of the text (e.g., literature essay, screenplay, etc.), a subcategory (e.g., character-driven prose), a genre of the text, and the like. The text classification LLM may also analyze the text data to determine a summary thereof, topics included in the text by which the text may be sorted, and one or more safety parameters with the text, such as hate speech, dangerous content, sexually explicit content, and more.

The trained text parsing LLM may output the parsed text data, including the passages and their profiles, and the text classification LLM may output the related classification and analysis data. The outputted parsed text data, namely the passages of one or more profiles, may then be assigned a voice. Voice assignments may be determined automatically based on analyzed parameters of the passages, such as tone, inflection, and character attributes, in some examples. Thus, the assigned voices may include corresponding inflections, speeds, volumes, and the like that match the passage profiles to which particular passages correspond. Alternatively, voice assignments may be determined in response to user input to a graphical user interface (GUI). The GUI may present the parsed text that identifies the different passage profiles. User input to the GUI may then indicate voice assignments for different passage profiles. One or more third party text-to-speech applications may be employed to generate audio narration based on the determined voice assignments.

In this way, via deployment of a trained text parsing LLM and a trained text classification LLM, text data may be parsed, classified, and analyzed in order to allow for multi-character audio narration. The system as herein described is configured to automatically assign a voice to individual passage profiles, thus generating a multi-character audio narration that allows the listener to distinguish characters by voice as well as textual clues. Further, the GUI presented by the system allows creators to customize audio narration content in a streamlined fashion, thus reducing time and monetary costs of publishing audio narrative works.

It should be understood that the brief description above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The present invention will be better understood from reading the following description of non-limiting embodiments, with reference to the attached drawings, wherein below:

FIG. 1 shows a block diagram of an exemplary audio narration system, in accordance with one or more embodiments of the present disclosure;

FIG. 2 shows a block diagram of an exemplary text parsing large language model training system, in accordance with one or more embodiments of the present disclosure;

FIG. 3 shows a flowchart illustrating an exemplary method for training a text parsing large language model, in accordance with one or more embodiments of the present disclosure;

FIG. 4 shows a flowchart illustrating an exemplary method for parsing and analyzing text data, in accordance with one or more embodiments of the present disclosure;

FIG. 5 shows a flowchart illustrating an exemplary method for automatic narration of parsed text data, in accordance with one or more embodiments of the present disclosure;

FIG. 6 shows a first example graphical user interface (GUI), in accordance with one or more embodiments of the present disclosure;

FIG. 7 shows a second example GUI, in accordance with one or more embodiments of the present disclosure;

FIG. 8 shows a third example GUI, in accordance with one or more embodiments of the present disclosure;

FIG. 9 shows the third example GUI with a first pop-up UI, in accordance with one or more embodiments of the present disclosure;

FIG. 10 shows a fourth example GUI, in accordance with one or more embodiments of the present disclosure;

FIG. 11 shows the fourth example GUI with a second pop-up UI, in accordance with one or more embodiments of the present disclosure;

FIG. 12 shows the fourth example GUI in a second configuration; and

FIG. 13 shows a high-level diagram illustrating an example neural network.

### DETAILED DESCRIPTION

The following description relates to various embodiments of an audio narration system. In particular, systems and methods for text parsing using a trained text parsing large language model (LLM) and audio narration of the parsed text are provided. User inputs and data outputs from the trained text parsing LLM and audio narration are provided via one or more graphical user interfaces (GUIs).

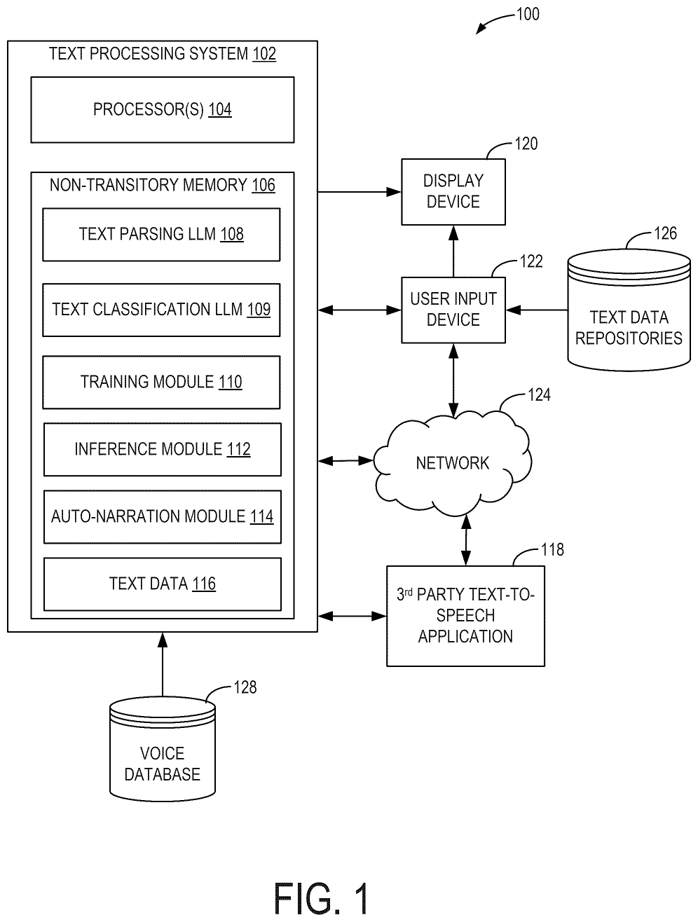

Starting with FIG. 1, a text processing system 102 of an audio narration system 100 is shown, in accordance with an embodiment of the present disclosure. In some embodiments, at least a portion of the text processing system 102 is disposed at a device (e.g., edge device, server, etc.). Text processing system 102 includes one or more processors 104 configured to execute machine readable instructions stored in non-transitory memory 106. Processor(s) 104 may be single core or multi-core, and the programs executed thereon may be configured for parallel or distributed processing. In some embodiments, the processor(s) 104 may optionally include individual components that are distributed throughout two or more devices, which may be remotely located and/or configured for coordinated processing. In some embodiments, one or more aspects of the processor(s) 104 may be virtualized and executed by remotely-accessible networked computing devices configured in a cloud computing configuration.

Non-transitory memory 106 may store a text parsing LLM 108 and a text classification LLM 109. The text parsing LLM 108 may be a trained text parsing LLM and the text classification LLM 109 may be a trained text classification LLM, as will be further described herein. It should be understood, however, that in some examples, the text parsing LLM 108 and the text classification LLM 109, while described as separate herein, may be incorporated into the same LLM.

Non-transitory memory 106 may further store a network training module 110, an inference module 112, an auto-narration module 114, and text data 116. The text parsing LLM 108 and the text classification LLM 109 may each include a deep learning network and instructions for implementing the deep learning network. The text parsing LLM 108 may be trained to parse text data into passage profiles, wherein each passage profile encompasses identified character attributes and passage tones. The text classification LLM 109 may be trained to classify the type of text (e.g., type of written work) and analyze the text data to determine related data such as genre, one or more safety parameters (e.g., presence of hate speech, sexually explicit content, etc.), a summary of the text data, and the like. The text parsing LLM 108 and the text classification LLM 109 may each include one or more trained and/or untrained neural networks and may further include various data, or metadata, pertaining to the one or more neural networks stored therein.

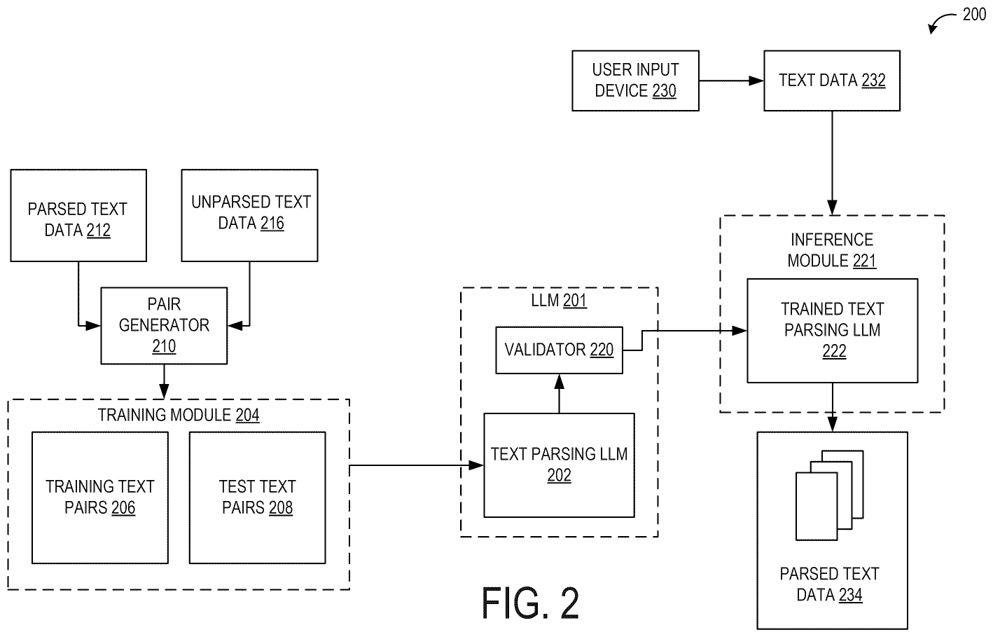

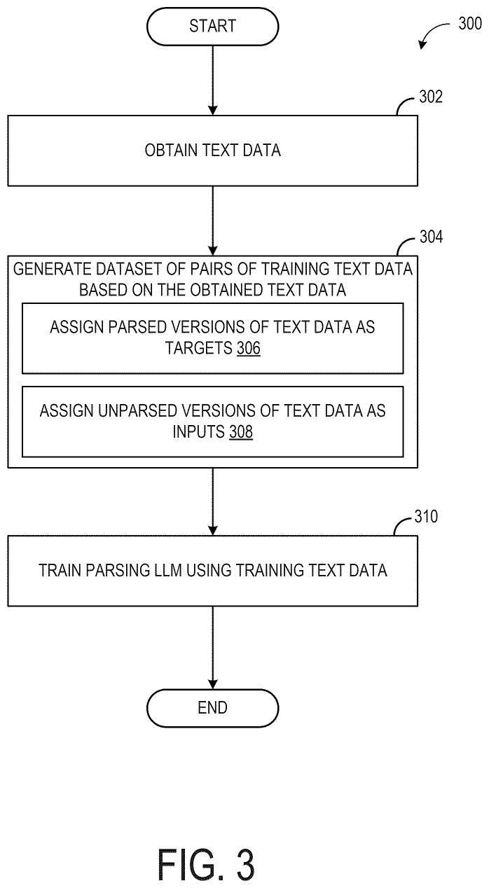

Training module 110 may comprise instructions for training one or more of the neural networks implementing an LLM stored in the text parsing LLM 108 and the text classification LLM 109. In particular, training module 110 may include instructions that, when executed by the processor(s) 104, cause the text processing system 102 to conduct one or more of the steps of a method for training the one or more of the LLMs in a training stage, discussed with respect to FIGS. 2 and 3. For example, the training module 110 may access text data, in some examples portions of text data 116 stored in non-transitory memory 106. The portions of text data 116 that are accessed by the training module 110 may include written works and corresponding parsed versions of the written works that may thus form training data for which the text parsing LLM 108 may be trained upon. In some embodiments, training module 110 may include instructions for implementing one or more gradient descent algorithms, applying one or more loss functions, and/or training routines, for use in adjusting parameters of the one or more neural networks of the text parsing LLM 108 and/or the text classification LLM 109. Non-transitory memory 106 may also store the inference module 112 that comprises instructions for parsing and analyzing new text data with the trained LLMs.

In some examples, related data outputs of the text parsing LLM may be used for audio narration. For example, the character attributes that are encompassed within the passage profiles may be used for assigning a voice to each passage profile. Conversely, related data outputs of the text classification LLM may not be used for audio narration. For example, a summary of the text data and a genre of the text data may be outputted but not used to generate narration.

As noted, non-transitory memory 106 further stores the text data 116. The text data 116 may include, for example, available written works, in both unaltered format and parsed format, for which the text parsing LLM 108 may be trained on. The text data 116 may additionally include newly acquired written works, such as those received from a user input device 122 in which the text processing system 102 is in communication with.

The text processing system 102 may be operably/communicatively coupled to the user input device 122 and a display device 120. In some examples, the display device 120 may be incorporated as part of the user input device 122. The user input device 122 may comprise one or more of a touchscreen, a keyboard, a mouse, a trackpad, a motion sensing camera, or other device configured to enable a user to interact with and manipulate data within the text processing system 102. For example, the user may select voices to assign, modes of voice assignment (e.g., multi-voice mode vs single-voice mode), and the like as will be herein described. The display device 120 may include one or more display devices utilizing virtually any type of technology. In some embodiments, display device 120 may comprise a smart phone screen and may display one or more GUIs. As an example, the user input device 122 may include the display device 120 and may be a smart phone or tablet configured with a touchscreen display. In yet further examples, the user input device 122 may include the text processing system 102 thereon. For example, the text processing system 102 may be downloaded as an application and stored in memory of a smart phone. Thus, the display device 120 may be combined with the processor(s) 104, the non-transitory memory 106, and/or the user input device 122 in a shared enclosure, or may be peripheral display devices and may comprise a monitor, touchscreen, projector, or other display device known in the art, which may enable the user to view the parsed text data in one or more GUIs and/or interact with the parsed text data via the one or more GUIs.

The user input device 122 may be communicatively and/or operably coupled to one or more text data repositories 126. The one or more text data repositories 126 may comprise any database accessible by the user input device 122 from which text data may be obtained. As an example, the user input device 122 may obtain a written work from one of the one or more text data repositories 126 and may input the written work into the text processing system 102. For example, the text processing system 102, via a GUI, may prompt the user to input text data from one or more sources, such as a folder of a file explorer application, an online storage medium, or the like. In some examples, the user input device 122 may also be configured to ingest audio data (e.g., user created audio data) and then text of the audio data may be generated via a speech-to-text application either within the user input device 122 and/or the text processing system 102.

In some examples, both the text processing system 102 and the user input device 122 may be communicatively and/or operably coupled to a network 124. For example, the text processing system 102 may be configured to access the network 124 in order to obtain voices from a voice database 128. The user input device 122 may be coupled to the network 124 in order to communicate with the text processing system 102, obtain text data from the one or more text data repositories 126, and the like. The voice database 128, in some examples, may include one or more databases of available voices from which the text processing system may choose voices to assign to various passage profiles. For example, based on the attributes of a particular character, as determined by the LLM, an auto-narration module 114 may select a corresponding voice from the voice database 128 that fits with the character's profile (e.g., tone of the character, etc.).

Further, the text processing system 102 may be operably and/or communicatively coupled to one or more third party text-to-speech applications 118. The one or more third party text-to-speech applications 118 may be configured to convert the parsed text data to audio. In some examples, the one or more third party text-to-speech applications 118 may include their own voice databases therewithin and the text processing system 102, via the auto-narration module 114 may select voices from the third party applications. In other examples, the text processing system 102 may export the parsed text data and the assigned voices, selected from the voice database 128 via one or more of the auto-narration module 114 and user inputs, to the third party text-to-speech application 118, which may then use the assigned voices to convert the parsed text data to audio narration. In some examples, the one or more third party text-to-speech applications 118 may be communicatively and/or operably coupled to the network 124. For example, the parsed text data and in some examples the assigned voices, may be transmitted from the text processing system 102 to the one or more third party text-to-speech applications 118 over the network 124. Further, the one or more third party text-to-speech applications 118 may transmit the corresponding audio narration back to the text processing system 102, in some examples over the network 124.

The text processing system 102 herein described is thus designed to automate the process of converting written works into audio narrations while maintaining character distinctiveness and appropriate narrative tone through AI-based text processing and voice assignment.

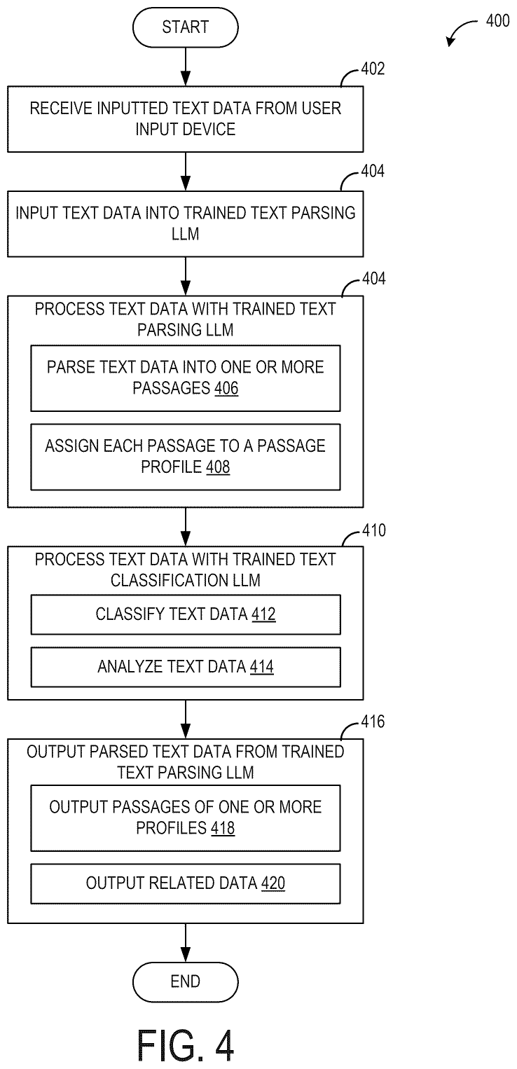

Turning now to FIG. 2, an example of an LLM training system 200 is shown. The LLM training system 200 herein described is a text parsing LLM training system 200, described with reference to a text parsing LLM (e.g., text parsing LLM 108 of FIG. 1), however it should be understood that the training system 200 is exemplary in nature and a similar training system with similar techniques may be employed for other LLMs of the present disclosure, such as a text classification LLM (e.g., the text classification LLM 109). The text parsing LLM training system 200 may be used to train an LLM such as a text parsing LLM 202. The text parsing LLM 202 may be trained to identify different types of passages (e.g., dialogue versus narration), identify passage profiles (e.g., character attributes, narrator attributes, etc.), determine related data of passages, including genre, topics, character attributes, and the like, classify the text data, and separate the passages and output them in machine-readable format with related data, in accordance with one or more operations described in greater detail below in reference to method 400 of FIG. 4. The text parsing LLM training system 200 may be implemented by a text processing system, such as text processing system 102 of FIG. 1, to train the text parsing LLM 202 to detect, process, and parse text data.

In some embodiments, the text parsing LLM 202 may be a deep neural network with a plurality of hidden layers. In one embodiment, the text parsing LLM 202 is a convolutional neural network (CNN).

The text parsing LLM 202 may be stored within an LLM module 201 of the text data processing system. The LLM module 201 may be a non-limiting example of text parsing LLM 108 of text processing system 102 of FIG. 1. Text parsing LLM training system 200 also includes a training module 204, which includes a training dataset comprising a plurality of training pairs of data, such as text data pairs divided into training text pairs 206 and test text pairs 208. Training module 204 may be a non-limiting example of training module 110 of text processing system 102 of FIG. 1.

A number of training text pairs 206 and test text pairs 208 may be selected to ensure that sufficient training data is available to prevent overfitting, whereby the text parsing LLM 202 learns to map features specific to samples of the training set that are not present in the test set.

Each text pair of the training text pairs 206 and the test text pairs 208 comprises an input text and an output text. The input text may be an unparsed written work and the output text may be a parsed version of the written work with identified character attributes of passage profiles. As an example, an input text may be a short story in an unaltered form and a corresponding output text may be a parsed version of the short story with a plurality of identified passage profiles and related data of tone of individual passages and character attributes. The input text data may be sourced from widely available written works, in some examples the input text data may be written works that have a corresponding audio narration thereof which may be used to generate the parsed versions for the output text data.

The text parsing LLM training system 200 may thus include parsed text data 212 and unparsed text data 216 which may be fed into the training module 304 in order to generate the training text pairs 206 and test text pairs 208. In some examples, each of the parsed text data 212 may correspond to one of the unparsed text data 216, thus allowing for mapping from unparsed to parsed. In some examples, a pair generator 210 may be used to generate the training text pairs 206 and the test text pairs 208 of the training module 204 from the parsed text data 212 and unparsed text data 216. Data of the unparsed text data 216 may be paired with data of the parsed text data 212 by the pair generator 210.

Once each text data pair is generated, the text pair may be assigned to either the training text pairs 206 or the test text pairs 208. In some examples, the text pair may be assigned to either the training text pairs 206 or the test text pairs 208 randomly in a pre-established proportion. For example, the text pair may be assigned to either randomly such that 90% of the text pairs generated are assigned to the training text pairs 206 and 10% of the text pairs generated are assigned to the test text pairs 208. Alternatively, the text pair may be assigned to either the training text pairs 206 or the test text pairs 208 randomly such that 85% of the text pairs generated are assigned to the training text pairs 206, and 15% of the text pairs generated are assigned to the test text pairs 208. It should be appreciated that the examples provided herein are for illustrative purposes, and text pairs may be assigned to the training text pairs 206 dataset or the test text pairs 208 dataset via a different procedure and/or in a different proportion without departing from the scope of this disclosure.

The text parsing LLM training system 200 may include a validator 220 that validates the performance of the text parsing LLM 202 against the test text pairs 208. The validator 220 may take as input a partially trained text parsing LLM 202 and a dataset of test text pairs 208, and may output an assessment of the performance of the partially trained text parsing LLM 202 on the dataset of test text pairs 208.

Once validated, a trained text parsing LLM 222 (e.g., the validated text parsing LLM 202) may be used to generate parsed text data 234 from an acquired text data 232. The acquired text data 232 may be new text data in an unparsed form that is received from a user input device 230 (e.g., user input device 122 of FIG. 1). The trained text parsing LLM 222 may be stored within an inference module 221 of the text processing system (e.g., inference module 112 of FIG. 1).

To reiterate, the text parsing LLM training system 200 as herein described is exemplary in nature and it should be appreciated that a similar system employing similar techniques may be used to train the text classification LLM as well. For example, a training system for the text classification LLM may take as input written works and as targets data such as a summary thereof, topics included therein, a language of the written work, a genre, and one or more safety parameters (e.g., presence of sexually explicit passages, hate speech, violence, etc.). The text classification LLM may thus be trained to ingest text data and output related data including a genre, language, a summary, and the like.

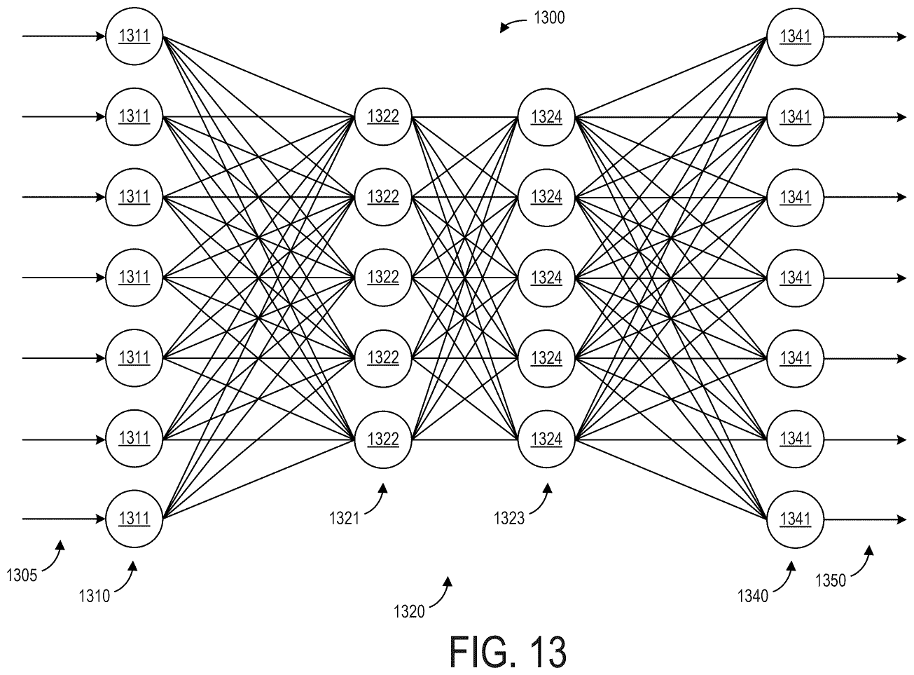

FIG. 13 shows a high-level diagram of an exemplary neural network 1300. The neural network 1300 may be an example of either the text classification LLM or the text parsing LLM described with respect to FIGS. 1 and 2, though it should be understood that the neural network 1300 may be implemented with other systems and components without departing from the scope of this disclosure.

Neural network 1300 includes an input layer 1310, a plurality of hidden layers 1320 including a first hidden layer 1321 and a second hidden layer 1323, and an output layer 1340. Each layer 1310, 1321, 1323, and 1340 includes a plurality of nodes, depicted as circles in FIG. 13. Specifically, input layer 1310 includes a plurality of input nodes 1311, first hidden layer 1321 includes a plurality of hidden nodes 1322, second hidden layer 1323 includes a plurality of hidden nodes 1324, and output layer 1340 includes a plurality of output nodes 1341. In one example, the hidden nodes 1322 and 1324 comprise artificial neurons (herein referred to as nodes) with non-linear activation functions that map weighted inputs to the output.

To parse text data or determine related data of text data (e.g., classify the text data) (depending on which LLM the neural network 1300 is), input text data 1305 are input to the neural network 1300 which in turn outputs a corresponding output, such as parsed text data including a plurality of passages or classifications of the text data, including genre, category, a summary, and the like as described herein. The output may correspond to the output nodes 1341 of outputs 1350. More specifically, each input text data 1305 is input into a corresponding input node 1311 of the input layer 1310. Each input node 1311 is connected to each hidden node 1322 of the first hidden layer 1321, as depicted by the lines connecting the input layer 1310 to the first hidden layer 1321. Each hidden node 1322 of the first hidden layer 1321 is connected to each hidden node 1324 of the second hidden layer 1323. Each hidden node 1324 is connected to each output node 1341 of the output layer 1340. Each output node 1341 of the output layer 1340 outputs to a corresponding node of outputs 1350.

In one example, the hidden nodes receive one or more inputs and sum them to produce an output. The sums of each node are weighted, and the sum is passed through a non-linear activation function. The resulting output may then be passed on to each node in the following layer.

Neural network 1300 may therefore comprise a feedforward neural network. In some examples, the neural network 1300 may be trained through backpropagation. To minimize total error, gradient descent may be used to adjust each weight in proportion to the derivative of the error with respect to that weight. In another example, global optimization methods may be used to train the weights of the neural network 1300.

It should be appreciated that, for simplicity, FIG. 13 illustrates a relatively small number of nodes, and that in practice the neural network 1300 may include many thousands of nodes. As an example, while seven input nodes 1311 are depicted in the input layer 1310, in some examples the input layer 1310 may include thousands of input nodes 1311. In one example, the input layer 1310 may include as many as 2,800 input nodes 1311, each input node 1311 configured to receive one input 1305 or data variable.

Moreover, although the neural network 1300 is depicted as including two hidden layers 1321 and 1323, it should be appreciated that the neural network 1300 may include from two to x hidden layers, where x is a positive integer greater than two.

Further, the number of hidden nodes 1322 in hidden layer 1321 and the number of hidden nodes 1324 in hidden layer 1323 is optimizable. For example, the number of hidden nodes may be based on the number of outputs or output nodes 1341. As an illustrative example, for a neural network model with two output nodes 1341, the optimal number of hidden nodes in the hidden layers 1320 may comprise two hundred hidden nodes. For two hidden layers 1321 and 1323, the two hundred hidden nodes may, in some examples, be distributed equally between the hidden layers such that the hidden layers have the same width. For example, hidden layer 1321 may include one hundred hidden nodes 1322 while hidden layer 1323 may include one hundred hidden nodes 1324. In contrast, for thirty output nodes 1341, the optimal number of hidden nodes in the hidden layers 1320 may comprise nine hundred hidden nodes. In this example, the hidden nodes may be distributed equally across the hidden layers 1320, such that hidden layer 1321 includes four-hundred-fifty hidden nodes 1322 while hidden layer 1323 includes four-hundred-fifty hidden nodes 1324. Similarly, as the number of output nodes 1341 in the output layer 1340 is increased, the optimal number of hidden nodes may also increase.

Although constructing hidden layers with equal widths or equal numbers of hidden nodes may comprise a simplest architecture for the neural network model, it should be appreciated that in some examples, the number of hidden nodes in each hidden layer 1320 may be different, such that the widths of the hidden layers are also different.

Turning now to FIG. 3, a flowchart illustrating a method 300 for training a text parsing LLM is shown. The text parsing LLM may be a non-limiting example of the text parsing LLM 202 of the text parsing LLM training system 200 of FIG. 2, in some examples. Method 300 may be executed by a processor of a text processing system, such as the text processing system 102 of FIG. 1. In some examples, some operations of method 300 may be stored in non-transitory memory of the text processing system (e.g., in a training module such as the training module 110 of the text processing system 102 of FIG. 1) and executed by a processor of the text processing system (e.g., one of the processor(s) 104 of FIG. 1). The text parsing LLM may be trained on training data comprising one or more sets of text pairs. Each text pair of the one or more sets of text pairs may comprise unparsed text data and corresponding parsed text data. The parsed text data may comprise text parsed into one or more passages with identified passage profiles thereof. Further, each of the one or more passages may correspond to a tone, as described below. In some examples, the one or more sets of text pairs may be stored in text data of the text processing system, such as the text data 116 of text processing system 102 of FIG. 1.

At 302, method 300 includes obtaining text data. As described above, the text data of the text processing system may at least partially comprise existing written works, such as short stories, screen plays, chapters of books, and more that are publically available. Parsed and processed versions of the existing written works may also be included in the text data of the text processing system. This text data, including both unparsed and parsed versions as well as related data thereof, may be obtained from memory.

At 304, method 300 includes generating a dataset of pairs of training text data based on the obtained text data. Each training pair may include an unparsed text and a parsed text. As described above, an unparsed text may be an unaltered version of the written work in its original form (e.g., in paragraph form, in screen play form, etc.). The parsed version of the text may be a version of the written work that is parsed into a plurality of passages each assigned to one of a plurality of profiles and to a tone. As such, generating the dataset of pairs of training text data may comprise assigning one of the parsed text and one of the unparsed text to a pair. As such, generating the dataset of pairs of training text data based on the obtained text data may comprise assigned parsed versions of the text data as targets, as noted at 306, and assigning unparsed versions of the text data as inputs, as noted at 308.

At 310, method 300 includes training the text parsing LLM on the training pairs. More specifically, training the text parsing LLM on the text pairs includes training the text parsing LLM to learn to map the unparsed text data to the parsed text data. In some examples, the text parsing LLM may comprise a generative neural network. In some examples, the text parsing LLM may comprise a generative neural network having a U-net architecture. In yet other examples, the text parsing LLM may include one or more convolutional layers, which in turn comprise one or more convolutional filters (e.g., a convoluted neural network architecture).

It should be appreciated that while the method 300 is described herein with reference to the text parsing LLM, similar steps of the method 300 may be applicable to other LLM, such as the text classification LLM. For example, text data may be obtained, a dataset of pairs of training text data based on the obtained text data may be generated, wherein unparsed versions of the text data are assigned as inputs and related data such as genre, language, a summary, topics, safety parameters, and the like, are assigned as targets. The text classification LLM may then be trained on the training text data similar to as described above.

With respect to training an LLM, such as the text parsing LLM or the text classification LLM, the convolutional filters of the architecture may comprise a plurality of weights, wherein the values of the weights are learned during a training procedure. The convolutional filters may correspond to one or more features/patterns, thereby enabling the text parsing LLM to identify and extract features from the text data to identify passages, identify and assign passage profiles (e.g., individual characters, narrators, etc.), and detect related data in individual passages such as tone and inflection as well as related data to the text data overall such as category, genre, character attributes, safety parameters, and the like. In other examples, the text parsing LLM may not be a convolutional neural network, rather may be a different type of neural network.

Training an LLM (e.g., the text parsing LLM and/or the text classification LLM) on the text pairs may include iteratively inputting text data of each text data pair into an input layer of the LLM. The LLM may map the input text data to a corresponding target text data by propagating the input text data from the input layer, through one or more hidden layers, until reaching an output layer of the LLM. In the example of the text parsing LLM, the output may be parsed text data with related tone of passage and character attributes of passage profiles. In the example of the text classification LLM, the output may be related data to the text including category, genre, and language data thereof as well as a summary of the text data, one or more topics included in the text data, and safety analysis data. As described above, the parsed text data may comprise one or more passages that are separated and identified by passage profile, whereby individual passages are assigned to a particular character, narrator, or other. The parsed text data may thus be outputted for further processing by the text processing system and/or assignment of voices for audio narration.

The LLMs may be configured to iteratively adjust one or more of the plurality of weights of the LLMs in order to minimize a loss function, based on an assessment of differences between the input text data and the target text data comprised by each text pair of the training text pairs. In some examples, the loss function is a Mean Absolute Error (MAE) loss function, where differences between the input text data and the target text data are compared on a pixel-by-pixel basis and summed. In another embodiment, the loss function may be a Structural Similarity Index (SSIM) loss function. In other embodiments, the loss function may be a minimax loss function, or a Wasserstein loss function. It should be appreciated that the examples provided herein are for illustrative purposes, and other types of loss function may be used without departing from the scope of this disclosure.

The weights and biases of an LLM may be adjusted based on a difference between the output text data and the target (e.g., ground truth) text data of the relevant text data pair. The difference (or loss), as determined by the loss function, may be backpropogated through the neural learning network to update the weights (and biases) of the convolutional layers. In some examples, back propagation of the loss may occur according to a gradient descent algorithm, wherein a gradient of the loss function (a first derivative, or approximation of the first derivative) is determined for each weight and bias of the deep neural network. Each weight (and bias) of the LLM is then updated by adding the negative of the product of the gradient determined (or approximated) for the weight (or bias) with a predetermined step size. Updating of the weights and biases may be repeated until the weights and biases of the LLM converge, or the rate of change of the weights and/or biases of the deep neural network for each iteration of weight adjustment are under a threshold.

In order to avoid overfitting, training of the given LLM may be periodically interrupted to validate a performance of the LLM on the test text data pairs. In some examples, training of the LLM may end when a performance of the LLM on the test text data pairs converges (e.g., when an error rate on the test set converges on or to within a threshold of a minimum value). In this way, the LLM may be trained to generate parsed text data, as herein described.

In some embodiments, an assessment of the performance of the given LLM may include a combination of a minimum error rate and a quality assessment, or a different function of the minimum error rates achieved on each text data pair of the test text data pairs and/or one or more quality assessments, or another factor for assessing the performance of the LLM. It should be appreciated that the examples provided herein are for illustrative purposes, and other loss functions, error rates, quality assessments, and/or performance assessments may be included without departing from the scope of this disclosure.

In some examples, training an LLM, such as the text parsing LLM, the text classification LLM, or another LLM that includes functionality of both the text parsing and text classification LLMs as herein described, may incorporate a feedback loop. For example, end-user actions with the output of the trained LLM, such as user interaction metrics (e.g., listening rates, drop-off points, etc.), may be fed back into the LLM during training. In this way, the LLMs may be adaptively updated based on user interactions with the outputs thereof.

As a non-limiting example, the feedback loop may provide dynamic real-time feedback for one or more LLMs and/or other rules-based models that assign voices based on parameters of a given character profile. For example, the training process of one or more of the LLMs may be updated in an iterative manner to continually improve outputs thereof. In another example, modules such as the auto-narration module described with respect to FIG. 1 may be rules-based and the rules thereof may be updated dynamically in real-time based on user interaction metrics.

For example, a first iteration of the auto-narration system herein described may assign a first voice to a determined character profile. In a second iteration following dynamic feedback update, the auto-narration system may assign a second, different voice to the same determined character profile. For example, listener drop-off points or other listener feedback metrics may indicate the first voice does not match the parameters (e.g., tone, attitude, etc.) of the determined passage profile. As another example, a first iteration of the audio narration system may assign a voice to each individual passage profile for a first subset of works and may assign a single voice to an entire work regardless of passage profile for a second subset of works. Listener feedback metrics may indicate that the single voice works perform better compared to the multi-voice works for a particular type of work. This information may then be inputted back into the audio narration system (e.g., into one or more LLMs, as herein described, or other modules thereof), thereby providing smart narration directly based on user interactions. In this way, the system, namely one or more of the described LLMs and/or other modules/models like the auto-narration module 114 may be updated in real-time based on end-user actions. Thus, listening experience for the listeners as well as engagement with the created works may be increased.

Referring now to FIG. 4, a flowchart illustrating a method 400 for parsing and processing text data using one or more trained LLMs, including a text parsing LLM and a text classification LLM, is shown. The text parsing LLM may be a non-limiting example of the text parsing LLM 108 of the text processing system 102 of FIG. 1, in some examples. The text classification LLM may be a non-limiting example of the text classification LLM 109 of FIG. 1, in some examples. Method 400 may be executed by a processor of a text processing system, such as the text processing system 102 of FIG. 1. In some examples, some operations of method 400 may be stored in non-transitory memory of the text processing system and executed by the processor of the text processing system (e.g., one of the processor(s) 104 of FIG. 1). The LLMs may each be trained on training data comprising one or more sets of text pairs as described with respect to FIG. 3. The text parsing LLM may be trained to identify passages of different profiles, identify tone of each passage and character attributes of each passage profile, and separate the passages and output them in a machine-readable format, as will be herein described. Further, the text classification LLM may be trained to identify related data of the text data, including type of work, genre, language, a summary, topics of the text data, and more, as will be herein described.

At 402, method 400 includes receiving inputted text data from a user input device. As described with respect to FIG. 1, the text processing system may be communicatively and/or operably coupled to the user input device, such as a desktop computer, laptop computer, smart phone, tablet, etc. The user input device may be configured to access one or more text data repositories that store written works. For example, the user input device may comprise non-transitory memory in which text data is stored. In other examples, the user input device may be configured to access one or more cloud platforms in which the text data is stored. The text data may be transmitted from the one or more text data repositories to the user input device and from the user input device to the text processing system.

At 404, method 400 includes processing the text data with the trained text parsing LLM to generate parsed text data and related data. As described previously, the trained text parsing LLM may be stored in non-transitory memory of the text processing system. The trained text parsing LLM may be trained on pairs of text data, as described with respect to method 300 of FIG. 3.

Processing the text data with the trained text parsing LLM may comprise parsing the text data into one or more passages, as noted at 406. Parsing the text into one or more passages may comprise identifying individual profiles (e.g., characters, narrators, and others), identifying prose corresponding to those profiles, and assigning each of the one or more passages to one of the passage profiles, as noted at 408. In some examples, identification of the individual passage profiles may include identifying character attributes, narrator attributes, and the like for given profiles such that each profile encompasses corresponding attributes. As an example, a written work of character-driven prose may comprise a plurality of characters with dialogue and a narrator, in a simple form. Each of the plurality of characters and the narrator may correspond to a particular passage profile. The text data may be parsed into individual passages and each passage may be linked to a character/narrator according to an identified passage profile.

At 410, method 400 includes processing the text data with the trained text classification LLM. Processing the text data with the trained text classification LLM may include classifying the text data, as noted at 412. Classifying the text data may include identifying a language in which the text data is written, identifying a category of the text data (e.g., literature, screen play, etc.), and in some examples a subcategory (e.g., character-driven prose, narrator-driven prose, etc.), and identifying a genre of the text data.

Processing the text data with the trained text classification LLM may further comprise analyzing the text data, as noted at 414. Analyzing the text data may comprise generating a summary of the text data, identifying one or more topics included in the text data, and generating a safety analysis of the text data. The safety analysis may indicate presence of one or more safety parameters, including presence of hate speech, presence of sexually explicit content, presence of violent themes, and the like.

Thus the related data may comprise data of the classification and the analysis. As will be further described herein, the related data may comprise audio-affecting related data, including category, language, character attributes, tone, and inflection, and non-audio affecting related data, including summary, genre, topics, and safety parameters. In some examples, the text parsing LLM may generate audio-affecting related data, such as the character attributes encompassed within each passage profile, and the text classification LLM may generate non-audio-affecting related data.

At 416, method 400 includes outputting parsed text data from the trained text parsing LLM. As described above, the parsed text data may comprise one or more passages of one or more passage profiles, as noted at 418. The parsed text data may additionally comprise related data to the parsed text data, as noted at 420, which may include tone of individual passages, a genre of the text, a language of the text, character attributes, one or more safety parameters, a summary of the text, and/or one or more topics included in the text data. As noted above, in some examples, the character attributes and tone of passages may be encompassed within the parsed passage data and/or the passage profiles.

In this way, inputted text data may be processed, parsed, and analyzed via the trained text parsing LLM and the trained text classification LLM. Thus, parsed text data, including passage data corresponding to one or more passage profiles and related data may be identified and outputted. Via deployment of the trained text parsing LLM, passages corresponding to individual characters and to narrators in various types of works may be identified and robustly separated in order for voices to be assigned thereto for automated audio narration of the text data.

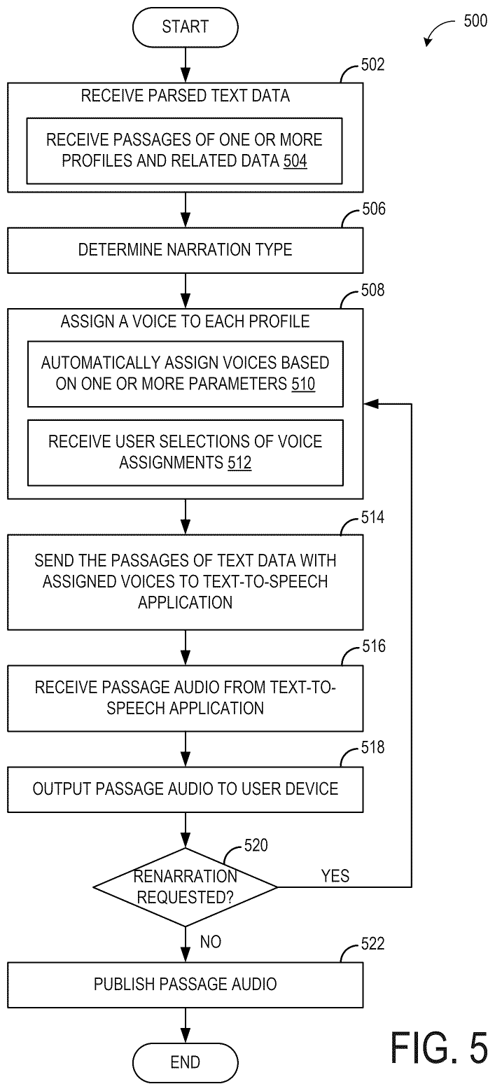

FIG. 5 shows a flowchart illustrating a method 500 for audio narration of parsed text data. The method 500 may be executed by an audio narration system, such as audio narration system 100 of FIG. 1, which includes a text processing system, such as text processing system 102 of FIG. 1 In particular, the method 500 may be executed by one or more processors of the text processing system. In some examples, some operations of method 400 may be stored in non-transitory memory of the text processing system and executed by the processor(s) of the text processing system (e.g., one of the processor(s) 104 of FIG. 1). The parsed text data may be processed, parsed, and analyzed by a trained text parsing LLM, as is described with respect to FIG. 4, in some examples. However, it should be understood that the parsed text data may be parsed in other manners, in some examples.

At 502, method 500 includes receiving parsed text data. In some examples, the parsed text data may be parsed and analyzed by trained text parsing LLM, as is herein disclosed, and the text data may be received as an output from the trained text parsing LLM. In other examples, the parsed text may be parsed and outputted in another manner. The parsed text data may comprise a plurality of passages of one or more passage profiles, as noted at 504. As described above, the text data may be parsed into individual passages, each of which may be assigned to a particular passage profile. Each passage profile may correspond to a character or a narrator. For example, in character-driven prose, multiple characters may be identified and a passage profile may correspond to each of the identified characters. Additionally, the parsed text data may comprise a plurality of related data as well, including audio-affecting related data including tone of individual passages, language, and character attributes, and non-audio-affecting related data including a genre, one or more safety parameters, topics in the text data, and a summary.

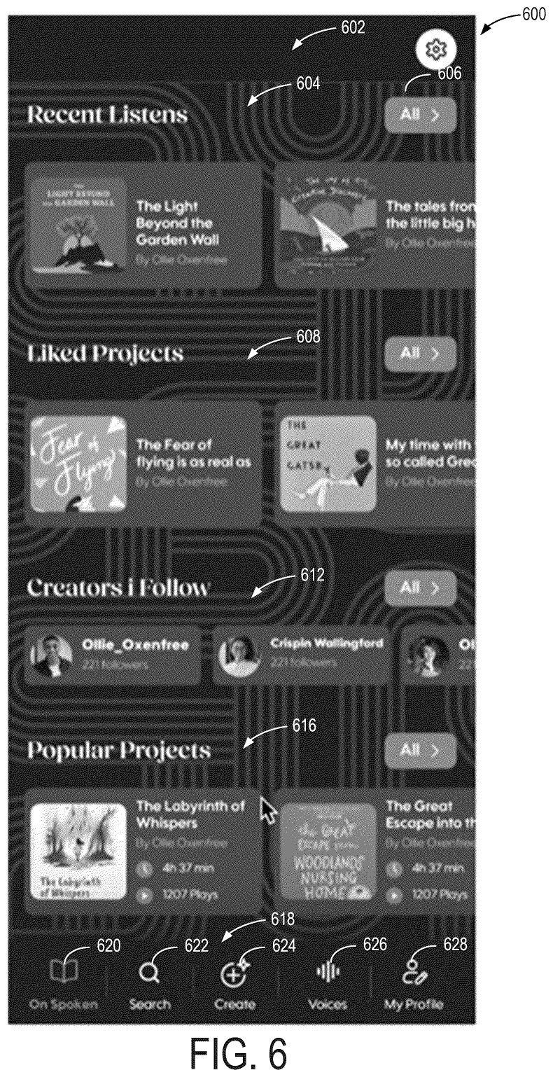

At 506, method 500 includes determining a narration type. In some examples, the narration type may be determined automatically based on the audio-affecting related data. For example, for parsed text data that is in the character-driven prose category, a preset narration type may be multi-character, multi-voice while for parsed text data that is in the narrator-only category, a preset narration type may be narration-only, single-voice. In this way, based on the category of written work as determined by the text parsing LLM, the narration type may be automatically determined. Alternatively or additionally, the narration type may be determined by user inputs. For example, a GUI may be displayed on a user input device that includes a plurality of selectable elements, as will be further described with respect to FIGS. 6-11. One of the plurality of selectable elements may allow the user to select a narration type from a list of available narration types. In some examples, a pre-selected narration type may be initially displayed based on the category of written work and the user may then select a different narration type from the list of available narration types based on their preferences. The narration type may inform how voices are assigned, in some examples.

At 508, method 500 includes assigning a voice to each passage profile. As noted, the parsed text data may comprise a plurality of passages each corresponding to one of one or more passage profiles. Multiple passages may correspond to the same passage profile. For example, each passage corresponding to a first character may belong to a first passage profile while each passage corresponding to a second character may belong to a second passage profile.

In some examples, voices may be automatically assigned based on one or more parameters, as noted at 510, and the narration type. The one or more parameters may include the audio-affecting related data of the related data determined by the LLM, such as overall tone and inflection of the passage profile, as well as character attributes detected via the processing by the text parsing LLM. For example, a narrator profile may be assigned a steady, calm voice, while a child character may be assigned a more excitable or vibrant sounding voice. The narration type may inform whether a single voice is assigned to the entire work or whether separate voices are assigned to each passage profile.

Additionally or alternatively, one or more user selections of voice assignments may be received via the user input device, as noted at 512. In some examples, auto-narration in which voices are automatically assigned may be unavailable in examples where the parameters of tone, inflection, and character attributes are unavailable or otherwise not determined by the text parsing LLM. In such examples, the user may individually select voices for each passage profile (e.g., for each character, the narrator, and/or others) from a list of available voices. In yet further examples, the voices may be initially assigned to each passage profile automatically based on the parameters as defined and/or the narration type and the user may then review the assigned voices and make changes via user input selections per their preferences.

At 514, method 500 includes sending the passages of text data with the assigned voices thereof to a third party text-to-speech application. As described with respect to FIG. 1, the text processing system may be in communication with one or more third party text-to-speech applications (e.g., the one or more third party text-to-speech applications 118), which may be configured to convert text to audio. The passages of text data and the assigned voices thereof may be sent to the text-to-speech application to convert the text to audio using the assigned voices for each passage. The text-to-speech application may thus generate passage audio for each passage of the parsed text data.

At 516, method 500 includes receiving passage audio from the third party text-to-speech application. The passage audio may be parsed into the same passages as the parsed text data. The passage audio may be configured in a machine readable format that may be outputted audibly by the user input device for the user to hear.

At 518, method 500 includes outputting the passage audio to a user device. In some examples, the user device may be the same as the user input device used to receive user inputs, for example via the GUI. The passage audio may be outputted in the format that can be heard by the user. For example, the passage audio may be outputted as individual files that are launched when the user selects a corresponding passage within a GUI.

At 520, method 500 includes determining whether renarration has been requested. Renarration, in this instance, includes repeating the voice assignment and speech-to-text conversion of the passages. Renarration may be requested by the user via user input to a GUI displayed on the user input device. For example, the user may listen to the outputted passage audio received from the text-to-speech application and may decide that different voice assignments are warranted, in which case they may select one or more elements indicating that a change in voice assignment is desired. If renarration is requested (YES at 520), method 500 returns to 508 to again assign voices. In some examples, once renarration is requested, auto-narration may no longer occur and assignment of voices may be based on user selections. In other examples, renarration with auto-narration may be requested. In some examples, a subset of voice assignments corresponding to a subset of the passage profiles may be repeated, while a remaining subject are unchanged. For example, the user may indicate a change in voice assignment for only one of the passage profiles. In other examples, renarration, such as request for repeated auto-narration, may include repeating voice assignments for all the available passage profiles.

If renarration is not requested (NO at 520), method 500 proceeds to 522 to publish the passage audio. In some examples, the text processing system may be in communication with, configured as part of, or otherwise coupled to an audio application that publically publishes outputs of the audio narration system. Users of the audio application may then access published works for listening.

In this way, users of the audio narration system may input a text file with text data, the text data may be processed, parsed, analyzed, and outputted via a trained text parsing LLM. The parsed text data may then be further processed for audio narration, in some instances for automatic audio narration and in other instances for user-aided audio narration. Thus, the user may more easily obtain audio narration versions of their text file and the audio narrated versions, once published, may be easily accessed by other users. In this way, a wider variety of written works may be available for public consumption. The audio narration system thus increases the efficiency of audio narration by way of deployment of the trained text parsing LLM.

Turning now to FIGS. 6-11, various GUIs are shown. The GUIs herein presented may be displayed on a display device of a user input device (e.g., display device 120 of user input device 122 of FIG. 1). The user input device may be communicatively and/or operably coupled to a text processing system (e.g., text processing system 102 of FIG. 1). Thus, in response to user inputs and selections of selectable elements within the various GUIs, the text processing system may take one or more actions as herein described.

Starting with FIG. 6, a first example GUI 600 is shown. The first GUI 600 may be a start page that is initially launched when an associated audio narration application is opened within the user input device. As previously described, the audio narration application may be a downloadable application of the user input device that communicates with or otherwise stores the text processing system (e.g., of the audio narration system 100 of FIG. 1).

The first GUI 600 may comprise a dashboard 602 including a plurality of headings. For example, the plurality of headings may include a recent listens heading 604, a liked projects heading 608, a followed creators heading 612, and a popular projects heading 616. The recent listens heading 604 may display one or more works that the user has recently listened to. The liked projects heading 608 may display one or more works that the user has “liked”. “Liking” as herein used may include selection of an element that saves a corresponding project. In some examples, the more users that like a project, the more popular the project may be. More popular projects may be promoted or shown to more users within the application, such as in the popular projects heading 616. The followed creators heading 612 may display one or more creators within the application that have been “followed” by the user. Similar to likes for projects, individual creators may have profile pages with a follow element. The follow element, when selected by the user, may indicate that the user wants to see projects from that creator and new works from that creator may be promoted more to the user than other projects. The popular projects heading 616 may display one or more projects that are popular application-wide. Popularity may be determined by number of likes, recent listens, and/or other activity associated with the project.

Each of the headings shown within the dashboard 602 may include an expansion element that when selected, launches a pop-up window displaying additional information. For example, a first expansion element 606 may correspond to the recent listens heading 604. The first expansion element 606 may be selectable and when selected via user input, may launch a pop-up window listing more recent listens than shown in the recent listens heading 604. For example, the pop-up window may list all recent listens within a given timeframe, such as in the last 6 months.

The dashboard 602 may further comprise a navigation panel 618. The navigation panel 618 may comprise a plurality of selectable elements that when selected launch different aspects of the application. For example, a first element 620 may be associated with the dashboard 602. Thus, when the first element 620 is selected, the dashboard 602 may be displayed. A second element 622 may be a search element that, when selected, launches a search GUI through which the user may search for works or creators. A third element 624 may be a create element that, when selected, launches an interface through which a user may input text data for parsing via a text parsing LLM and audio narration. A fourth element 626, when selected, may launch an interface showing a list of available voices for audio narration, each of which may link to an audio file that may be listened to when selected. A fifth element 628 may be a profile element that when selected, launches the user's profile within the application.

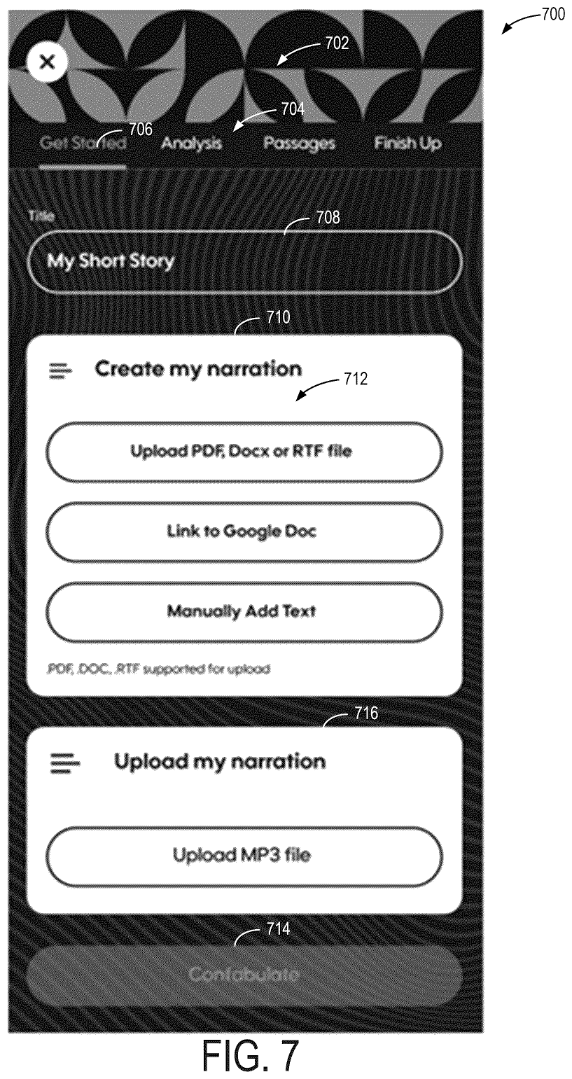

FIG. 7 shows a second example GUI 700. The second GUI 700 may be launched in response to user selection of the third element 624. The second GUI 700 may comprise an audio narration interface 702 that includes a plurality of headings 704 each identifying a step of the audio narration process. In the second GUI 700, a first heading 706 may be selected corresponding to input of text data.

The second GUI 700 may allow the user to input text data of an intended audio work that is to be parsed and narrated. For example, a title element 708 may be displayed. The title element 708 may be a selectable element that when selected allows the user to input (e.g., type via a keyboard, touchscreen, etc.) a desired title for the intended audio work.

A text input panel 710 may be displayed within the second GUI 700. The text input panel 710 may comprise a plurality of input elements 712 that allow the user to input the text data from one or more text data repositories. For example, a first input element of the plurality of input elements 712, when selected, may launch a window through which the user may upload a file stored in memory of the user input device (e.g., a PDF or text file). A second input element of the plurality of input elements 712, when selected, may launch a window linked to an online database through which the user may download a file of the text data. A third input element of the plurality of input elements 712, when selected, may launch a pop-up window through which the user may manually add the text data (e.g., by typing on a keyboard or touchscreen).

In some examples, a narration upload panel 716 may also be displayed within the second GUI 700. The narration upload panel 716 may allow the user to upload audio data, for example as an MP3 file. The uploaded audio data may be a user-created narration. In some examples, a speech-to-text application may convert the audio data to text that can then be processed. In some examples, the uploaded narration may be used as-is for audio narration and classification and analysis may be performed via the text classification LLM. In other examples, the uploaded narration may be converted to text and then parsed and processed for narration via the text parsing LLM.

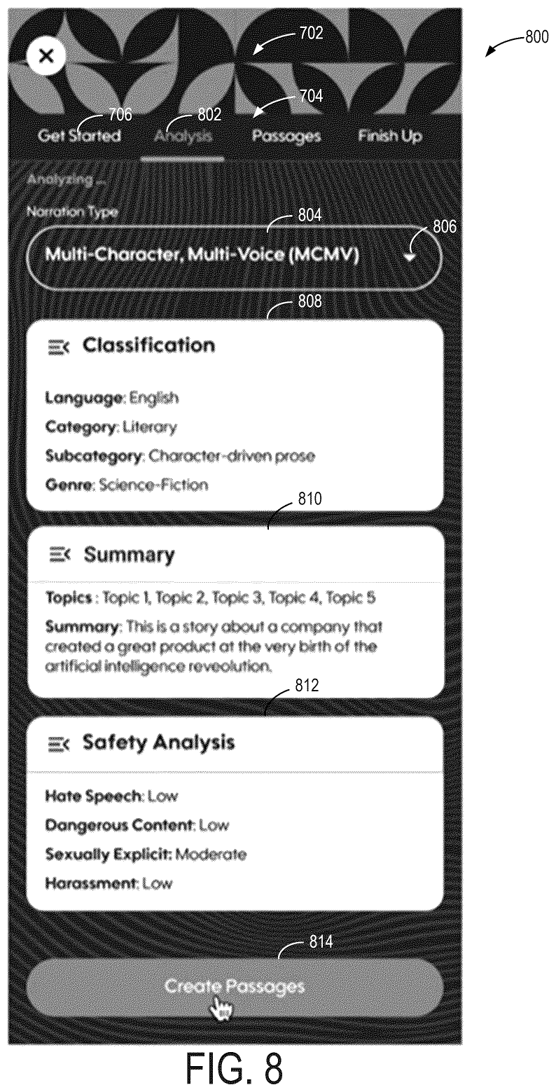

Once the text data has been inputted, a confabulate element 714 may be available for selection. The confabulate element 714, when selected, may trigger the text processing system to feed the inputted text data through the text parsing LLM, as described above. Additionally, in response to selection of the confabulate element 714, a third GUI 800, as shown in FIG. 8 may be displayed.

FIG. 8 shows the third GUI 800 which may be displayed in response to the text parsing LLM outputting parsed text data and related data. For example, the text processing system may deploy the text parsing LLM to parse and process the text data in response to user selection of the confabulate element 714 and in response to the text parsing LLM outputting parsed text data and related data, the third GUI 800 may be displayed.

The third GUI 800 may also include the audio narration interface 702 that includes the plurality of headings 704 each identifying a step of the audio narration process. In the third GUI 800, a second heading 802 may be selected corresponding to a step of text analysis.

The third GUI 800 may comprise a narration type element 804. The narration type element 804 may display a current narration type. As described above, the narration type may be automatically selected by the text processing system based on category of work of the text data, in some examples. The narration type element 804 may also be selectable via a drop down element 806 that, when selected, triggers display of a drop down menu of available narration types from which the user may select a desired narration type, if different from the automatically selected narration type.

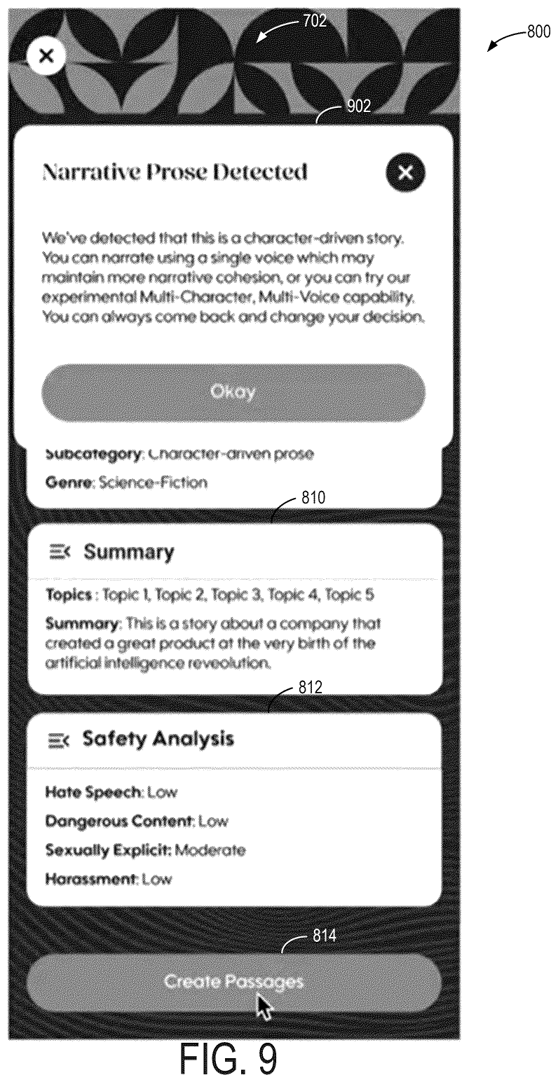

Turning briefly to FIG. 9, in some examples, automatic selection of a narration type may trigger display of a pop-up UI 902. The pop-up UI 902 may include information informing the user of a reasoning for the automatic selection of the narration type. For example, the pop-up UI 902 may describe that the category of work is character-driven prose and a multi-character, multi-voice narration type has been automatically selected based thereon. The pop-up UI 902 may be overlaid on the third GUI 800 and may be interacted with by the user separately from the elements of the third GUI 800.

Returning to FIG. 8, a plurality of panels may be displayed within the third GUI 800. A first panel 808 may display results of classification of the text data. As described with respect to method 500 of FIG. 5, processing the text data via the text parsing LLM may include classifying the data to determine a category of work, a language, and a genre. The first panel 802 may thus display a detected language, a detected category (e.g., literary, screen-play, essay, etc.) and subcategory (e.g., character-driven prose, narrator-only prose, etc.), and a genre (e.g., romance, science fiction, historical fiction, etc.).

A second panel 810 may display a summary of the text data. Also as described with respect to method 500, processing the text data may comprise analyzing the text data, which include generating a summary of the text data. The generated summary may be displayed within the second panel 810. A third panel 812 may display one or more safety parameters of the text data. Analysis of the data via the text parsing LLM that generates the summary also determines one or more safety parameters, including presence of hate speech, dangerous content, sexually explicit content, and the like. The one or more determined safety parameters may be displayed within the third panel 812.

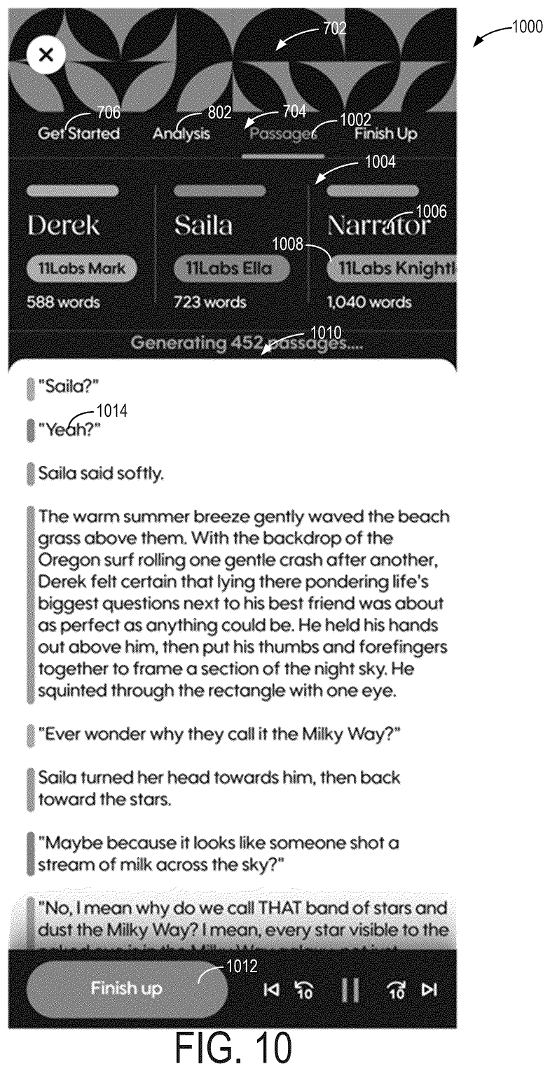

The third GUI 800 may also comprise a create element 814 that, when selected, triggers display of a fourth GUI (e.g., fourth GUI 1000 shown in FIG. 10). The create element 814 may trigger display of the one or more passages that are included in the parsed text data.

FIG. 10 shows the fourth GUI 1000. As noted, the fourth GUI 1000 may be displayed in response to user selection of the create element 814. The fourth GUI 1000, similar to the second GUI 700 and third GUI 800, may include the audio narration interface 702 that includes the plurality of headings 704 each identifying a step of the audio narration process. In the fourth GUI 1000, a third heading 1002 may be selected corresponding to a third step in which passages are assigned to voices.

The fourth GUI 1000 may display one or more passage profiles 1004. The one or more passage profiles 1004, as described above, may correspond to the characters and/or narrator of the written work. For example, in character-drive prose, as demonstrated in FIG. 10, each of the passage profiles may correspond to one of the characters of the work or the narrator of the work. Each of the passage profiles 1004 may be assigned to a voice automatically, in some examples. For example, in the multi-character, multi-voice narration type, each passage profile may be assigned a different voice.

Each of the displayed one or more passage profiles 1004 may include a passage profile identifier (e.g., a name of the character, a narrator identifier, etc.) and an assigned voice. For example, a first passage profile 1006, identified as narrator, may be assigned to voice 1008. The voice 1008 may be a selectable element that, when selected via user input, may launch a pop-up UI that lists the available voices.

In some examples, auto-narration (e.g., automatic voice assignment) may be not be available. In such examples, rather than the voice (e.g., voice 1008), each of the one or more passage profiles 1004 may display an assign voice element that when selected launches the GUI of available voices. Then, once a voice is selected, the selected voice may be displayed (e.g., as the voice 1008) for the corresponding passage profile.

The fourth GUI 1000 may also display one or more passages 1010 of the parsed text data. The one or more passages 1010 may be displayed in an order corresponding to the inputted text data. In some examples, each of the one or more passage profiles 1004 may be color coded and each of the one or more passages 1010 may be color coded to correspond to the colors of the one or more passage profiles 1004, thereby allowing for easy identification of which passage profile (e.g., which character or narrator) corresponds to the shown passages. In another example, the profile identifier (e.g., character name or narrator) may be displayed before each displayed passage.

Further, each of the one or more passages 1010 may also be selectable elements that, when selected, launch the GUI of available voices. In some examples, once voices have been assigned, either manually via user inputs or automatically based on determined character attributes, passage tone, and the like, an accept element 1012 may become selectable. The accept element 1012 may trigger the parsed text data and assigned voices to be fed through a third party text-to-speech application that may convert the one or more passages to audio with the assigned voices. In some examples, the fourth GUI 1000 may display a progress bar as the audio is generated by the text-to-speech application, indicating which passages have available audio and which passages are yet to be converted.

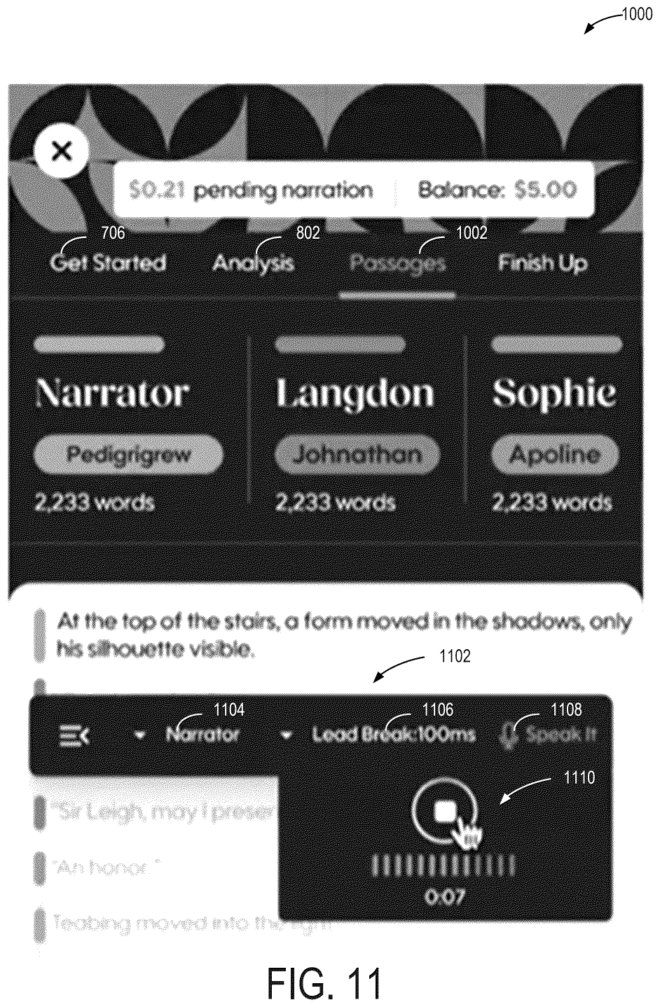

In some examples, individual passages may be fed through the third party text-to-speech application. For example, user selection of a first passage 1014 of the one or more passages 1010 may launch a pop-up UI. An exemplary second pop-up UI 1102 is shown in FIG. 11. The second pop-up UI 1102 may be displayed as an overlay on the fourth GUI 1000, for example over the selected first passage 1014.

The second pop-up UI 1102 may comprise a profile element 1104. The profile element 1104 may display which passage profile the selected first passage 1014 corresponds to. In some examples, the profile element 1104 may be selectable to display a drop down menu of available passage profiles. The user may select a different passage profile for the first passage 1014 if so warranted (e.g., if the passage profile determined during parsing is incorrect).

The second pop-up UI 1102 may additionally comprise a lead break element 1106. The lead break element 1106 may display a currently defined lead break for the first passage 1014. The lead break may be a timeframe of a pause between the start of the first passage 1014 and a previously narrated passage in a corresponding audio narration output. The lead break element 1106 may be selectable to display a drop down menu of available lead break timeframes from which the user may select a desired lead break.

The second pop-up UI 1102 may also comprise a narrate element 1108. The narrate element 1108, when selected, may trigger the first passage 1014 to be fed through the text-to-speech application and a corresponding audio passage to be outputted. Selection of the narrate element 1108 may also trigger display of a narration panel 1110. The narration panel 1110 may indicate wherein the first passage 1014 a currently playing audio passage thereof is. The user may pause, restart, and otherwise scrub through the currently playing audio passage via the narration panel 1110.

Pop-up UIs similar to the second pop-up UI 1102 may be displayable for each of the one or more passages 1010. In this way, the user may preview how the assigned voices sound for each individual passage. This may help to inform the user whether a change in assigned voices is desired. Further, via these pop-up UIs, the user may preview the sound of the selected narration type. If a change in narration type is desired, for example after previewing the sound of the currently selected narration type, the user may toggle back to the third GUI 800, via the second heading 802, to select a different narration type.

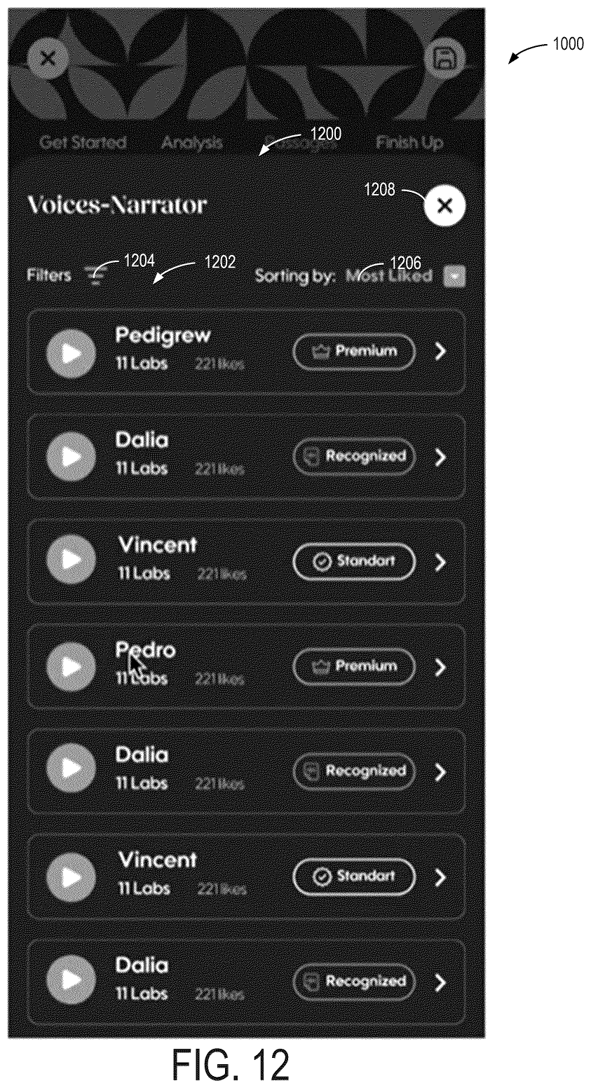

Turning to FIG. 12, a third pop-up UI 1200 is shown. The third pop-up UI 1200 may be displayed as an overlay on the fourth GUI 1000, in some examples. The third pop-up UI 1200 may be displayed in response to one or more user selections. For example, in response to selection of an assigned voice element, such as voice 1008, an assign voice element (e.g., as is displayed within a passage profile panel when auto-narration is unavailable), and/or one of the one or more passages 1010, the third pop-up UI 1200 may be displayed on top of the fourth GUI 1000.

The third pop-up UI 1200 may comprise a list 1202 of available voices that the user may choose from. The list 1202 of available voices may correspond to a particular passage profile, for example to a passage profile of a corresponding voice element that is selected to launch the pop-up UI. In some examples, each of the voices in the list 1202 may be selectable in various manners. For example, a first type of selection may assign the voice to the corresponding passage profile while a second type of selection may allow the user to listen to the selected voice. In other examples, selection of the voice may assign it to the passage profile while selection of a drop down menu element may allow the user to listen to the voice. Each voice in the list 1202, as displayed, may include information such as which database the voice is sourced from, a tier of the voice, and a number of likes. In some examples, the tier of the voice may indicate a level of quality of the voice.

The third pop-up UI 1200 may also comprise a filter element 1204 that, when selected, may display a drop down menu through which the user may filter which voices are presented in the list 1202. For example, the user may filter by gender of voice, tier of voice, database source, etc. Further, a sort element 1206 may be selectable to display a drop down menu through which the user may select how to sort the list 1202. For example, the list 1202 may be sorted by number of likes, tier, and more.

A close element 1208, when selected, may close the third pop-up UI 1200 and return to display of the fourth GUI 1000. In some examples, the close element 1208 may close the third pop-up UI 1200 without any change to the voice assignments. In other examples, the user may assign voices via the third pop-up UI 1200 and then close the UI via the close element with the voice assignments saved.

In this way, via the various GUIs herein described, a user may input text data to the text processing system, view resulting parsed text data and related data, assign voices to passages and/or view automatically assigned voices, and use a third party text-to-speech application to generate audio of the parsed text data.

The technical effect of the systems and methods herein provided is that users can generate audio narrations of their written works in a more accessible manner. The audio narration system may utilize a trained text parsing LLM to robustly parse inputted text data into a plurality of passages of one or more passage profiles, as well as process the data to classify and analyze the text data. The audio narration system may take this parsed data and assign voices to each passage of the parsed data, either automatically based on character attributes and passage attributes or via user selections to a GUI. In this way, audio narration may be performed of text data without needing someone to read the text out loud. Thus, a wider range of written works may be accessible to consumers who prefer to ingest audio content and generating audio narrated works may be more accessible to creators.

The systems and methods described herein provide several technical improvements and advantages over conventional text processing and audio narration systems. The trained text parsing LLM enables automated identification and separation of passages based on complex character attributes and narrative elements that would be difficult to achieve through traditional rule-based text processing. By implementing a neural network architecture with multiple hidden layers and non-linear activation functions, the system can recognize subtle patterns in text that indicate character voice, tone, and other attributes that inform proper voice assignment. This deep learning approach allows the system to handle nuanced cases where simple keyword or pattern matching would fail.

The dual-LLM architecture, with separate text parsing and classification models working in parallel or series, provides technical advantages in terms of processing efficiency and accuracy. By dividing the computational tasks between specialized models, the system can process text data more efficiently than a single general-purpose model while maintaining high accuracy for both parsing and classification tasks. The text parsing LLM focuses on the granular task of passage separation and profile assignment, while the classification LLM handles broader document-level analysis, allowing each model to be optimized for its specific function.

The system's dynamic feedback loop implementation represents a technical advancement over static text-to-speech systems. By incorporating real-time user interaction metrics and listening patterns into the model training process, the system can continuously optimize voice assignments and narrative flow. This adaptive learning capability allows the system to improve accuracy and natural speech patterns over time based on actual usage data rather than remaining fixed after initial training.

The automated voice assignment system implements novel technical solutions for matching synthesized voices to parsed text passages. Rather than relying on simple one-to-one mapping of voices to characters, the system analyzes multiple parameters including character attributes, passage tone, speaking speed requirements, and contextual elements to select appropriate voices from available voice databases. This multi-parameter analysis enables more natural and contextually appropriate voice selection than conventional systems that use fixed voice assignments.

The system's modular architecture, with separate training, inference, and auto-narration modules, provides technical benefits in terms of scalability and maintainability. New voice models can be added to the voice database without requiring changes to the core text processing components. Similarly, the text parsing and classification models can be updated or retrained independently as needed. This modularity also enables distributed processing across multiple devices or cloud-based resources for improved performance with large documents or high user loads.

The implementation of standardized interfaces between components, particularly for voice assignment and text-to-speech integration, represents a technical improvement in system integration capabilities. The system can interface with multiple third-party text-to-speech engines while maintaining consistent voice assignment logic and quality control. This standardization enables broader compatibility with existing audio production tools while preserving the advanced parsing and voice selection capabilities of the core system.

These technical improvements enable the system to process complex narrative texts and generate high-quality multi-voice narrations with significantly reduced manual intervention compared to traditional audio narration approaches. The combination of advanced machine learning models, dynamic feedback incorporation, and modular architecture creates a technically sophisticated system that addresses the specific challenges of automated audio narration in ways that would not be possible through conventional text processing or simple text-to-speech conversion.

In another representation, the system and methods herein disclosed provide dynamic feedback loop implementation, wherein the model(s) are updated in real-time based on user interaction metrics, including listener drop-off point analysis, optimization of voice selection via adaptive learning, and performance metric tracking. The system also provides quality control features, including automated voice consistency checking, audio quality validation, pronunciation accuracy verification, timing and pacing optimization, and the like. The system also provides cross-document pattern recognition, including genre-specific optimization, character archetype learning, and context-aware voice selection.

The disclosure also provides support for a method for an audio narration system, comprising: receiving text data, generating, from the text data, parsed text data and related data, wherein the parsed text data comprises a plurality of passages of one or more passage profiles, assigning one or more voices to the plurality of passages based on the related data, and generating audio data of the parsed text data, wherein the audio data comprises an audio passage for each of the plurality of passages. In a first example of the method, generating the parsed text data comprises deploying a trained text parsing large language model (LLM), wherein the trained text parsing LLM is trained to separate passages of the text data and determine the one or more passage profiles, wherein each of the one or more passage profiles encompasses corresponding character attributes. In a second example of the method, optionally including the first example, generating the related data comprises deploying a trained text classification LLM, wherein the trained text classification LLM is trained to classify and analyze the text data. In a third example of the method, optionally including one or both of the first and second examples, the related data comprises a category of the text data, a genre of the text data, one or more topics of the text data, one or more safety parameters of the text data, a language of the text data, and tone of one or more of the plurality of passages. In a fourth example of the method, optionally including one or more or each of the first through third examples, the one or more voices are assigned to the plurality of passages based on the related data automatically. In a fifth example of the method, optionally including one or more or each of the first through fourth examples, the method further comprises: adjusting the one or more assigned voices based on user input. In a sixth example of the method, optionally including one or more or each of the first through fifth examples, the one or more voices comprise a voice for each of the one or more passage profiles. In a seventh example of the method, optionally including one or more or each of the first through sixth examples, the one or more voices comprise a single voice for all of the one or more passage profiles.

The disclosure also provides support for an audio narration system, comprising: a processor communicably coupled to non-transitory memory storing one or more neural networks, the non-transitory memory including instructions that when executed cause the processor to: receive text data from a user input device, process the text data with a first neural network, wherein processing the text data with the first neural network includes parsing the text data into a plurality of passages each corresponding to one of one or more passage profiles, process the text data with a second neural network, wherein processing the text data with the second neural network includes classifying the text data and analyzing the text data, assign one or more voices to the plurality of passages of the parsed text data, and via a text-to-speech application, outputting audio narration of the text data based on the one or more voices. In a first example of the system, analyzing the text data comprises determining a genre of the text data, one or more topics included in the text data, a summary of the text data, and one or more safety parameters of the text data, and wherein classifying the text data includes determining a category and subcategory of the text data. In a second example of the system, optionally including the first example, each of the one or more passage profiles encompasses one or more corresponding character attributes. In a third example of the system, optionally including one or both of the first and second examples, the one or more voices are assigned automatically based on the one or more character attributes and a narration type, wherein the narration type is determined based on the category of the text data. In a fourth example of the system, optionally including one or more or each of the first through third examples, the parsed text data and the audio narration of the text data are outputted to the user input device via a graphical user interface (GUI). In a fifth example of the system, optionally including one or more or each of the first through fourth examples, the audio narration is a multi-voice audio narration. In a sixth example of the system, optionally including one or more or each of the first through fifth examples, the one or more voices comprises a voice for each of the one or more passage profiles.

The disclosure also provides support for a method for generating audio narration of text data comprising: processing the text data via a trained text parsing large language model (LLM) and a trained text classification LLM to generate parsed text data and related data, respectively, wherein the parsed text data comprises a plurality of passages each corresponding to a passage profile, automatically assigning one or more voices to the parsed text data based on the related data, transmitting the parsed text data and the one or more assigned voices to a third party text-to-speech application, receiving, from the third party text-to-speech application, audio narration of the text data based on the parsed text data and one or more assigned voices. In a first example of the method, the one or more assigned voices include an assigned voice for each passage profile when a narration type is multi-character, multi-voice. In a second example of the method, optionally including the first example, the related data comprises audio-affecting related data, including category of work, character attributes, and tone of passages, and non-audio-affecting related data, including genre, topics included in the text data, a summary of the text data, and one or more safety parameters. In a third example of the method, optionally including one or both of the first and second examples, the one or more voices are automatically assigned based on the audio-affecting related data. In a fourth example of the method, optionally including one or more or each of the first through third examples, the method further comprises: outputting the audio narration to a user device.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

1. A method for an audio narration system, comprising:
receiving text data;
generating, from the text data, parsed text data and related data, wherein the parsed text data comprises a plurality of passages of one or more passage profiles;
assigning one or more voices to the plurality of passages based on the related data; and
generating audio data of the parsed text data, wherein the audio data comprises an audio passage for each of the plurality of passages.

2. The method of claim 1, wherein generating the parsed text data comprises deploying a trained text parsing large language model (LLM), wherein the trained text parsing LLM is trained to separate passages of the text data and determine the one or more passage profiles, wherein each of the one or more passage profiles encompasses corresponding character attributes.

3. The method of claim 1, wherein generating the related data comprises deploying a trained text classification LLM, wherein the trained text classification LLM is trained to classify and analyze the text data.

4. The method of claim 3, wherein the related data comprises a category of the text data, a genre of the text data, one or more topics of the text data, one or more safety parameters of the text data, a language of the text data, and tone of one or more of the plurality of passages.

5. The method of claim 1, wherein the one or more voices are assigned to the plurality of passages based on the related data automatically.

6. The method of claim 1, further comprising adjusting the one or more assigned voices based on user input.

7. The method of claim 1, wherein the one or more voices comprise a voice for each of the one or more passage profiles.

8. The method of claim 1, wherein the one or more voices comprise a single voice for all of the one or more passage profiles.

9. An audio narration system, comprising:
a processor communicably coupled to non-transitory memory storing one or more neural networks, the non-transitory memory including instructions that when executed cause the processor to:
receive text data from a user input device;
process the text data with a first neural network, wherein processing the text data with the first neural network includes parsing the text data into a plurality of passages each corresponding to one of one or more passage profiles;
process the text data with a second neural network, wherein processing the text data with the second neural network includes classifying the text data and analyzing the text data;
assign one or more voices to the plurality of passages of the parsed text data; and
via a text-to-speech application, outputting audio narration of the text data based on the one or more voices.

10. The audio narration system of claim 9, wherein analyzing the text data comprises determining a genre of the text data, one or more topics included in the text data, a summary of the text data, and one or more safety parameters of the text data, and wherein classifying the text data includes determining a category and subcategory of the text data.

11. The audio narration system of claim 10, wherein each of the one or more passage profiles encompasses one or more corresponding character attributes.

12. The audio narration system of claim 11, wherein the one or more voices are assigned automatically based on the one or more character attributes and a narration type, wherein the narration type is determined based on the category of the text data.

13. The audio narration system of claim 9, wherein the parsed text data and the audio narration of the text data are outputted to the user input device via a graphical user interface (GUI).

14. The audio narration system of claim 9, wherein the audio narration is a multi-voice audio narration.

15. The audio narration system of claim 14, wherein the one or more voices comprises a voice for each of the one or more passage profiles.

16. A method for generating audio narration of text data comprising:
processing the text data via a trained text parsing large language model (LLM) and a trained text classification LLM to generate parsed text data and related data, respectively, wherein the parsed text data comprises a plurality of passages each corresponding to a passage profile;
automatically assigning one or more voices to the parsed text data based on the related data;
transmitting the parsed text data and the one or more assigned voices to a third party text-to-speech application;
receiving, from the third party text-to-speech application, audio narration of the text data based on the parsed text data and one or more assigned voices.

17. The method of claim 16, wherein the one or more assigned voices include an assigned voice for each passage profile when a narration type is multi-character, multi-voice.

18. The method of claim 16, wherein the related data comprises audio-affecting related data, including category of work, character attributes, and tone of passages, and non-audio-affecting related data, including genre, topics included in the text data, a summary of the text data, and one or more safety parameters.

19. The method of claim 18, wherein the one or more voices are automatically assigned based on the audio-affecting related data.

20. The method of claim 16, further comprising outputting the audio narration to a user device.
